(19) United States
(12) Patent Application Publication
(10) Pub. No.: US 2015/0348227 A1
(43) Pub. Date: Dec. 3, 2015

(54) DRAWING DATA GENERATION DEVICE, DRAWING DATA GENERATION METHOD AND DISPLAY DEVICE

(71) Applicant: Mitsubishi Electric Corporation, Tokyo (JP)

(72) Inventors: Tomoaki SAITO, Tokyo (JP); Daisuke KISARA, Tokyo (JP); Atsushi HORI, Tokyo (JP)

(73) Assignee: MITSUBISHI ELECTRIC CORPORATION, Tokyo (JP)

(21) Appl. No.: 14/759,071

(22) PCT Filed: Feb. 10, 2014
(86) PCT No.: PCT/JP2014/053055

§ 371 Date: Jul. 2, 2015

(30) Foreign Application Priority Data
Feb. 12, 2013 (JP) 2013-024451

(51) Int. Cl. G06T 1/20; G06T 11/40; G06F 3/14

(52) U.S. Cl. CPC G06T 1/20; G06F 3/14; G06T 11/40; G06T 2200/28

(57) ABSTRACT

At the time each of the components is to be drawn according to the drawing orders determined by a drawing-order determination unit 12, a drawing-data generation unit 14 generates, when another component having an overlap in drawing area with the component has been searched by an overlapped-component search unit 13, drawing data for indicating drawing of an area in the drawing area of that component except for its drawing area overlapped with the other component if the drawing order of that component is earlier than the drawing order of the other component, or drawing data for indicating drawing of all drawing area of that component if the drawing order of that component is later than the drawing order of the other component.

### TECHNICAL FIELD

The present invention relates to a drawing data generation device and drawing data generation method for generating drawing data of a screen formed of a plurality of components, as well as to a display device for drawing the components according to the drawing data generated by the drawing data generation device.

### BACKGROUND ART

According to a drawing data generation device disclosed, for example, in the following Patent Document 1, when generating drawing data of a screen formed of a plurality of components, the drawing orders of the plurality of components are determined according to a drawing rule in which, among the plurality of components, the component used for a background is firstly drawn followed by drawing so that the more the component is to be placed toward the front side of the screen, the later it is drawn.

Upon determining the drawing orders of the respective components, the drawing data generation device generates drawing data for indicating drawing of all drawing areas of the respective components, followed by outputting information indicative of the drawing orders with the drawing data to a display device.

Upon receiving the information indicative of the drawing orders of the respective components with the drawing data, the display device performs drawing according to the drawing data of these components in precedence order of the component in the drawing orders.

Note that, in some cases, there is an overlapped drawing area between plural components, and in that area, overwriting for drawing is performed (drawing processing is doubly performed).

### CITATION LIST

### Patent Document

Patent Document 1: Japanese Patent Application Laid-open No. H11-224343

### SUMMARY OF THE INVENTION

### Problems to be Solved by the Invention

Since the conventional drawing data generation device is configured as described above, at the time each of the components is drawn, drawing processing for causing light emission in a specified color is performed for every pixel forming the drawing area of the component. Thus, the processing load in drawing processing increases as the number of pixels forming the drawing area becomes larger. Accordingly, in order to reduce the processing load in drawing processing, it suffices to decrease the number of pixels of the processing target; however, with respect to pixels in an area where drawing areas of plural components are overlapped to each other, drawing processing is doubly performed, resulting in waste of the drawing processing for the component in the background-side. Thus, there is a problem that the processing load in drawing processing is large and, therefore, the drawing performance is degraded.

This invention has been made to solve the problem as described above, and an object thereof is to provide a drawing data generation device and drawing data generation method that can generate drawing data by which wasteful drawing processing is eliminated so that the processing load in drawing processing becomes smaller.

Further, another object of this invention is to provide a display device which has a small processing load in drawing processing and thus can achieve an enhanced drawing performance.

### Means for Solving the Problems

A drawing data generation device according to the invention is provided with: a drawing-order determination processor that determines drawing orders of a plurality of components for forming a screen, according to a drawing rule in which, among the plurality of components, the component used for a background is firstly drawn followed by drawing so that the more the component is to be placed toward a front side of the screen, the later the component is drawn; and an overlapped-component search processor that compares drawing areas of the plurality of components for forming the screen to each other, to thereby search a component having an overlap in drawing area with another component; wherein, at the time each of the components is to be drawn according to the drawing orders determined by the drawing-order determination processor, a drawing-data generation processor generates drawing data for indicating drawing of all drawing area of the component when another component having an overlap in drawing area with said component has not been searched by the overlapped-component search processor, while generating, when another component having an overlap in drawing area with said component has been searched by the overlapped-component search processor, drawing data for indicating drawing of an area in the drawing area of said component except for its drawing area overlapped with the other component if the drawing order of said component is earlier than the drawing order of the other component, or drawing data for indicating drawing of all drawing area of said component if the drawing order of said component is later than the drawing order of the other component.

### Effect of the Invention

According to the invention, it is so configured that, at the time each of the components is to be drawn according to the drawing orders determined by the drawing-order determination processor, the drawing-data generation processor generates, when another component having an overlap in drawing area with the component has been searched by the overlapped-component search processor, drawing data for indicating drawing of an area in the drawing area of said component except for its drawing area overlapped with the other component if the drawing order of said component is earlier than the drawing order of the other component, or drawing data for indicating drawing of all drawing area of said component if the drawing order of said component is later than the drawing order of the other component. Thus, there is provided such an effect that it is possible to generate drawing data by which wasteful drawing processing is eliminated so that the processing load in drawing processing becomes smaller.

### BRIEF DESCRIPTION OF THE DRAWINGS

FIG. 1 is a configuration diagram showing a display device to which a drawing data generation device according to Embodiment 1 of the invention is applied.

FIG. 2 is a configuration diagram showing the drawing data generation device according to Embodiment 1 of the invention.

FIG. 3 is a flowchart showing processing details by the drawing data generation device 2 (drawing data generation method) according to Embodiment 1 of the invention.

FIG. 4 is an illustration diagram showing a design example of a screen drawn by a display device 3.

FIG. 5 is an illustration diagram showing an example of drawing orders of components determined by a drawing-order determination unit 12.

FIG. 6 is an illustration diagram showing an example of generating drawing data of the respective components.

FIG. 7 is an illustration diagram showing an EVEN/ODD rule in vector graphics drawing.

### MODES FOR CARRYING OUT THE INVENTION

Hereinafter, for illustrating this invention in more detail, embodiments for carrying out the invention will be described in accordance with the accompanying drawings.

### Embodiment 1

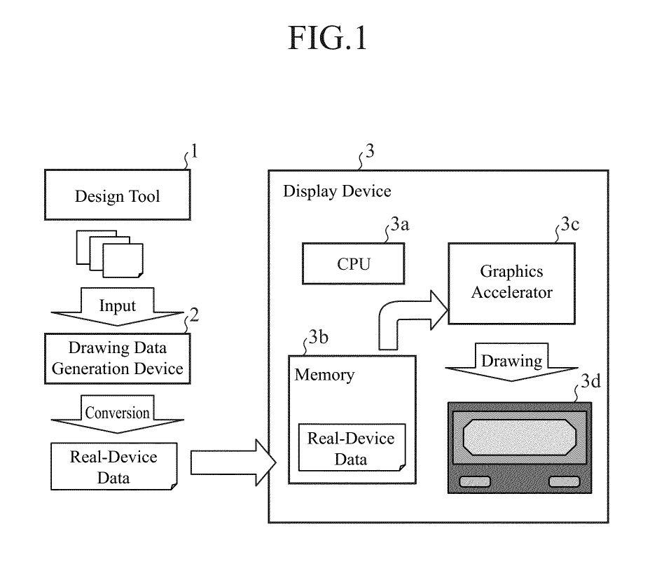

FIG. 1 is a configuration diagram showing a display device to which a drawing data generation device according to Embodiment 1 of the invention is applied.

In FIG. 1, a design tool 1 is software implemented by an unshown computer and performs processing of making a design of a screen to be drawn by a display device 3 and outputting design data indicative of the design.

In the design data, there are included information of a plurality of components for forming the screen (for example, arrangement of the components and hierarchical relationships on the screen among the respective components) and the like.

The drawing data generation device 2 is a device that determines drawing orders of the respective components from the design data outputted from the design tool 1, and generates drawing data for indicating drawing of drawing areas of respective components and then outputs real device data comprising information indicative of the drawing orders and the drawing data, to the display device 3.

The display device 3 is configured with a CPU 3a, a memory 3b, a graphics accelerator 3c and a display 3d, in which, when the real device data outputted from the drawing data generation device 2 is stored in the memory 3b, under direction of the CPU 3a and with reference to the information indicative of the drawing orders of the respective components included in the real device data, the graphics accelerator 3c recognizes the drawing orders of the respective components to thereby perform drawing processing on the display 3d in precedence order of the component in the drawing orders according to the drawing data of said component. Note that the graphics accelerator 3c constitutes a component drawing processor.

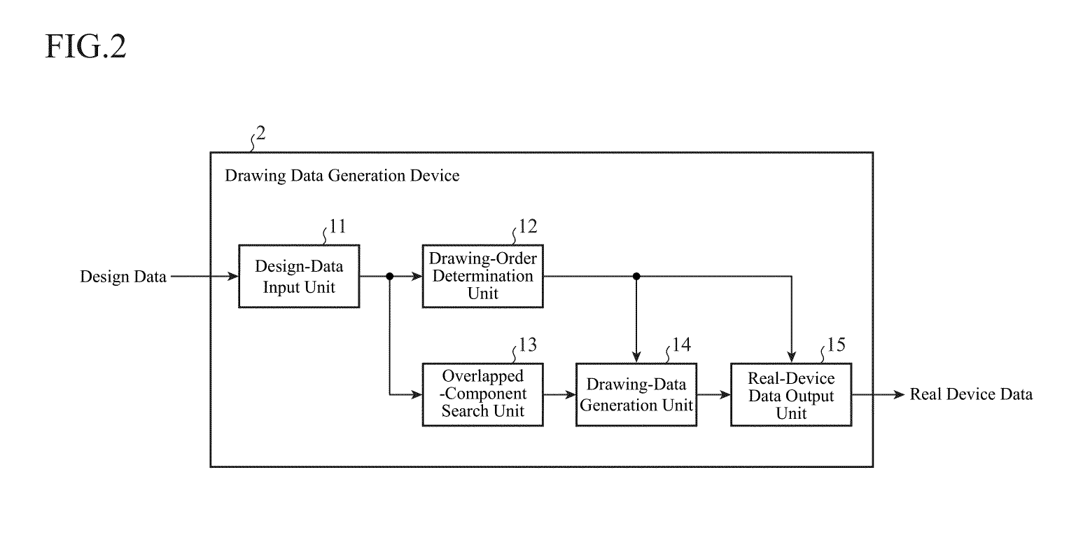

FIG. 2 is a configuration diagram showing the drawing data generation device according to Embodiment 1 of the invention.

In FIG. 2, a design-data input unit 11 is an input interface for inputting the design data outputted from the design tool 1.

A drawing-order determination unit 12 is configured, for example, with a CPU-mounted semiconductor integrated circuit, a single chip microcomputer or the like, and recognizes the hierarchical relationships on the screen among the plurality of components for forming the screen with reference to the design data inputted by the design-data input unit 11, to thereby perform processing of determining the drawing orders of the plurality of components according to a drawing rule in which, among the plurality of components for forming the screen, the component used for a background is firstly drawn followed by drawing so that the more the component is to be placed toward the front side of the screen, the later it is drawn. Note that the drawing-order determination unit 12 constitutes a drawing-order determination processor.

An overlapped-component search unit 13 is configured, for example, with a CPU-mounted semiconductor integrated circuit, a single chip microcomputer or the like, and recognizes the positional relationships among the plurality of components for forming the screen with reference to the design data inputted by the design data-input unit 11, to thereby perform search processing of a component having an overlap in drawing area with another component. Note that the overlapped-component search unit 13 constitutes an overlapped-component search processor.

A drawing-data generation unit 14 is configured, for example, with a CPU-mounted semiconductor integrated circuit, a single chip microcomputer or the like, and performs, at the time each of the components is to be drawn according to the drawing orders determined by the drawing-order determination unit 12, processing of generating drawing data for indicating drawing of all drawing area of the component when another component having an overlap in drawing area with said component has not been searched by the overlapped-component search unit 13.

In contrast, when another component having an overlap in drawing area with said component has been searched by the overlapped-component search unit 13, the drawing-data generation unit performs processing of generating drawing data for indicating drawing of an area in the drawing area of said component except for its drawing area overlapped with the other component if the drawing order of said component is earlier than the order of the other component, or processing of generating drawing data for indicating drawing of all drawing area of said component if the drawing order of said component is later than the order of the other component.

Note that the drawing-data generation unit 14 constitutes a drawing-data generation processor.

An real-device data output unit 15 is an output interface for outputting the real device data including the information indicative of the drawing orders of the respective components determined by the drawing-order determination unit 12 and the drawing data of the respective components generated by the drawing-data generation unit 14, to the display device 3.

In the example of FIG. 2, it is assumed that the design-data input unit 11, the drawing-order determination unit 12, the overlapped-component search unit 13, the drawing-data generation unit 14 and the real-device data output unit 15, which are configuration elements of the drawing data generation device 2, are each configured by dedicated hardware; however, the drawing data generation device 2 may be configured by a computer.

In the case where the drawing data generation device 2 is configured by a computer, it suffices to store in a memory of the computer, the programs in which processing details of the design-data input unit 11, the drawing-order determination unit 12, the overlapped-component search unit 13, the drawing-data generation unit 14 and the real-device data output unit 15 are written, and to cause a CPU of the computer to implement the programs stored in the memory.

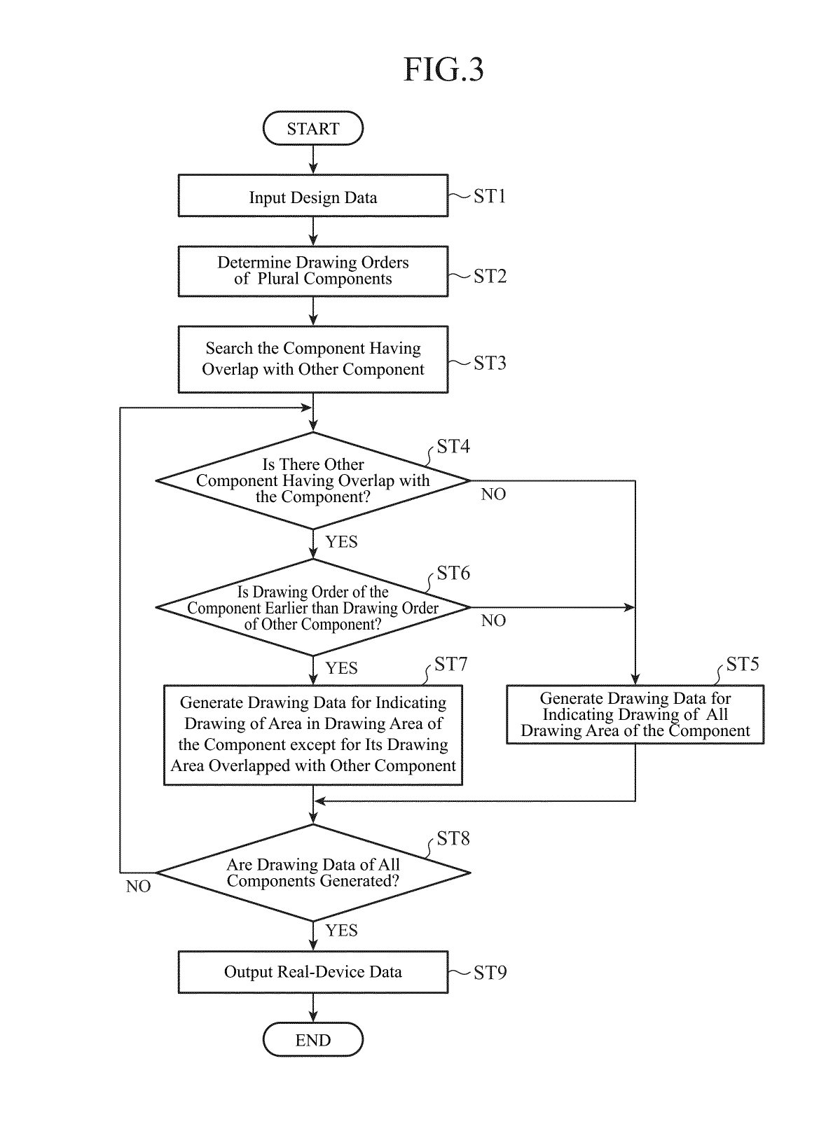

FIG. 3 is a flowchart showing processing details by the drawing data generation device 2 (drawing data generation method) according to Embodiment 1 of the invention.

Next, operations will be described.

The design tool 1 is implemented on the unshown computer and, under direction of a user, for example, makes a design of the screen to be drawn by the display device 3, and outputs the design data indicative of the design.

In the design data, there are included information of the plurality of components for forming the screen (for example, arrangement of the components, hierarchical relationships on the screen among the respective components, and drawing color of each pixel in the drawing area of each component) and the like.

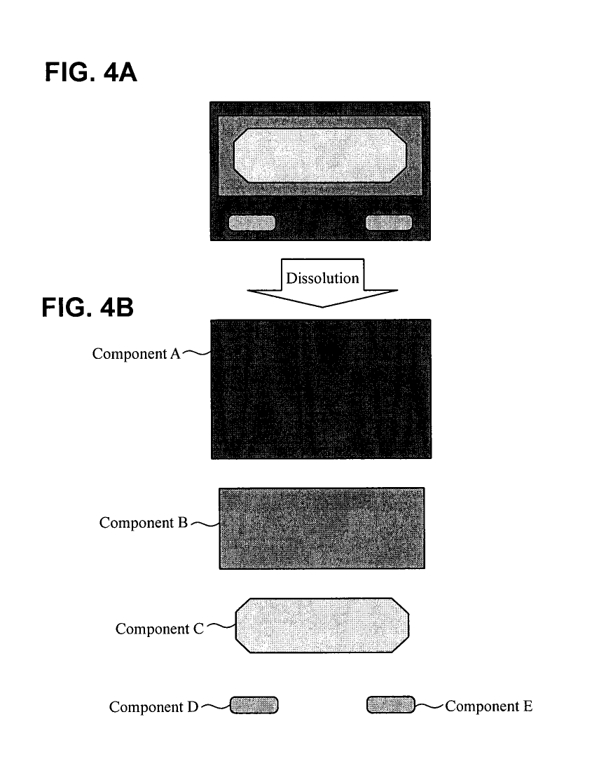

FIG. 4 is an illustration diagram showing a design example of a screen drawn by the display device 3.

In this example, as shown at FIG. 4(b), the screen is formed of Component A, Component B, Component C, Component D and Component E, and when Component A, Component B, Component C, Component D and Component E are drawn, there is provided a design of the screen as shown at FIG. 4(a).

The design-data input unit 11 of the drawing data generation device 2 inputs the design data outputted from the design tool 1, and outputs the design data to the drawing-order determination unit 12 and the overlapped-component search unit 13 (Step ST1 in FIG. 3).

Upon receiving the design data from the design-data input unit 11, the drawing-order determination unit 12 recognizes the hierarchical relationships on the screen among the plurality of components for forming the screen with reference to the design data, to thereby determine the drawing orders of the plurality of components according to the drawing rule in which, among the plurality of components for forming the screen, the component used for a background is firstly drawn followed by drawing so that the more the component is to be placed toward the front side of the screen, the later it is drawn (Step ST2).

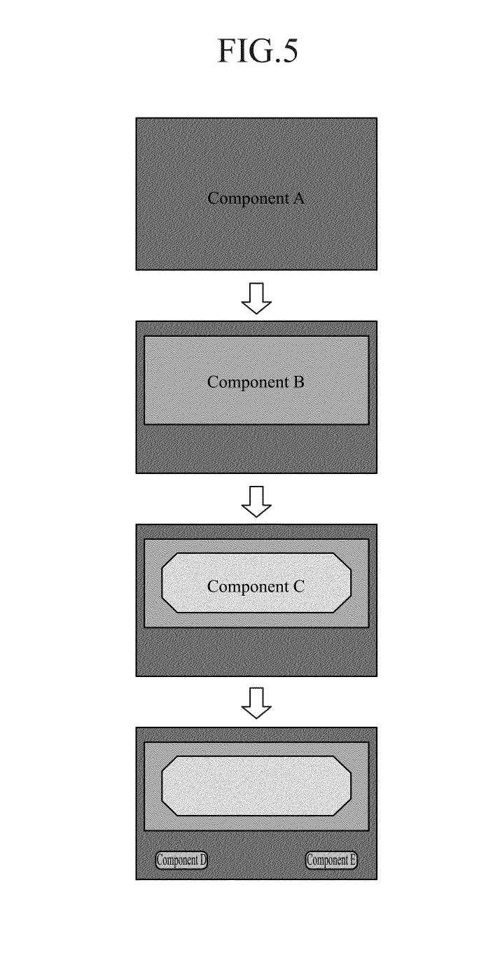

In this regard, FIG. 5 is an illustration diagram showing an example of the drawing orders of the components determined by the drawing-order determination unit 12. In the example of FIG. 5, the drawing orders are determined such that drawing is performed in the order of Component A→Component B→Component C→Components D and E.

Upon receiving the design data from the design-data input unit 11, the overlapped-component search unit 13 recognizes the positional relationships among the plurality of components for forming the screen (Component A, Component B, Component C, Component D and Component E) with reference to the design data, to thereby search a component having an overlap in drawing area with another component (Step ST3).

In the example of FIG. 4, Component A is determined to have overlaps with the drawing areas of Component B, Component D and Component E, and Component B is determined to have an overlap with the drawing area of Component C.

When the drawing-order determination unit 12 determined the drawing orders of the respective components, the drawing-data generation unit 14 confirms, at the time each of the components is to be drawn according to the drawing orders, whether or not the search result by the overlapped-component search unit 13 indicates presence of another component having an overlap in drawing area with the component (Step ST4).

In the example of FIG. 4, since every component has an overlap in drawing area with any other component, there is confirmed no component to be determined not to have an overlap in drawing area with the other component.

For example, in such a case where a screen is formed of Component X for filling the left area of the screen and Component Y for filling the remaining right area of the screen, Component X and Component Y are each confirmed not to have an overlap in drawing area with the other component.

In this case, the drawing-data generation unit 14 refers to drawing color of each pixel in each drawing area of the components indicated by the design data, to thereby generate drawing data for indicating drawing of all drawing area of Component X (drawing data that specifies drawing color of each pixel in the left area of the screen) and generates drawing data for indicating drawing of all drawing area of Component Y (drawing data that specifies drawing color of each pixel in the right area of the screen) (Step ST5).

When the presence of another component having an overlap in drawing area with said component is confirmed, the drawing-data generation unit 14 compares the drawing order of said component with the drawing order of the other component having the overlap in drawing area with reference to the information indicative of the drawing orders determined by the drawing-order determination unit 12, to thereby confirm whether or not the drawing order of said component is earlier than the drawing order of the other component (Step ST6).

In the example of FIG. 5, although the drawing orders are determined such that drawing is performed in the order of Component A→Component B→Component C→Components D and E as described above, at the time of generating drawing data of Component A, the drawing order of Component A is compared with the drawing orders of Component B, Component D and Component E, so that the drawing order of Component A is confirmed to be earlier than the drawing orders of Component B, Component D and Component E.

Further, at the time of generating drawing data of Component B, the drawing order of Component B is compared with the drawing orders of Component A and Component C, so that the drawing order of Component B is confirmed to be later than that of Component A but earlier than that of Component C.

At the time of generating drawing data of Component C, the drawing order of Component C is compared with the drawing order of Component B, so that the drawing order of Component C is confirmed to be later than that of Component B.

At the time of generating drawing data of Components D and E, the drawing order of Components D, E is compared with the drawing order of Component A, so that the drawing order of Components D, E is confirmed to be later than that of Component A.

When the drawing order of said component is confirmed to be earlier than the drawing order of the other component, the drawing-data generation unit 14 refers to drawing color of each pixel in the drawing area of said component indicated by the design data, to thereby generate drawing data for indicating drawing of an area in the drawing area of said component except for its drawing area overlapped with the other component (drawing data that specifies drawing color of each pixel in the area except for the drawing area overlapped with the other component) (Step ST7).

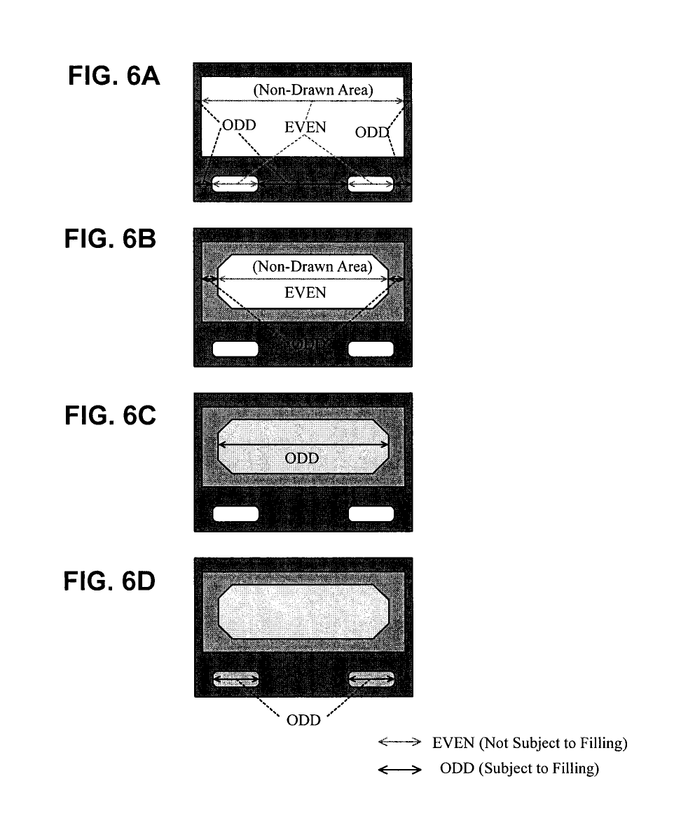

In this respect, FIG. 6 is an illustration diagram showing an example of generating drawing data of the respective components.

For example, the drawing order of Component A is earlier than the drawing orders of Component B, Component D and Component E, and thus, as shown at FIG. 6(a), the drawing-data generation unit generates drawing data that specifies drawing color of each pixel in an area in the drawing area of Component A except for drawing areas (white blank areas in the figure) overlapped with Component B, Component D and Component E.

When the drawing order of said component is confirmed to be later than the drawing order of the other component, the drawing-data generation unit 14 refers to drawing color of each pixel in the drawing area of said components indicated by the design data, to thereby generate drawing data for indicating drawing of all drawing area of said component (drawing data that specifies drawing color of each pixel in the all drawing area) (Step ST5).

For example, the drawing order of Component C is later than the drawing order of Component B, and thus, as shown at FIG. 6(c), the drawing-data generation unit generates drawing data that specifies drawing color of each pixel in all drawing area of Component C.

Further, the drawing order of Components D, E is later than the drawing order of Component A, and thus, as shown at FIG. 6(d), the drawing-data generation unit generates drawing data that specifies drawing color of each pixel in all drawing areas of Component D, E.

Note that, the drawing order of Component B is later than the drawing order of Component A but is earlier than the drawing order of Component C, and thus, as shown at FIG. 6(b), the drawing-data generation unit generates drawing data that specifies drawing color of each pixel in an area in the drawing area of Component B except for its drawing area overlapped with Component C (a white blank area in the figure).

In the data generation processing by the drawing-data generation unit 14, processing from Steps ST4 to ST7 is repeatedly performed until drawing data of all of the components are generated (Step ST8).

When the drawing-data generation unit 14 generated the drawing data of all of the components, the real-device data output unit 15 outputs to the display device 3, the real device data including the drawing data of all of the components and the information indicative of the drawing orders of the respective components determined by the drawing-order determination unit 12 (Step ST9).

The real device data outputted from the real-device data output unit 15 is stored in the memory 3b of the display device 3.

When the real device data is stored in the memory 3b, the CPU 3a of the display device 3 outputs a screen drawing command to the graphics accelerator 3c.

The graphics accelerator 3c is configured, for example, with a GPU (Graphics Processing Unit), and performs reading of the real device data from the memory 3b upon receiving the screen drawing command from the CPU 3a.

Then, with reference to the information indicative of the drawing orders of the respective components included in the real device data, the graphics accelerator 3c recognizes the drawing orders of the respective components to thereby draw on the display 3d in precedence order of the component in the drawing orders according to the drawing data of said component.

As is clear from the above, according to Embodiment 1, it is configured so that, at the time each of the components is to be drawn according to the drawing orders determined by the drawing-order determination unit 12, the drawing-data generation unit 14 generates, when another component having an overlap in drawing area with the component has been searched by the overlapped-component search unit 13, drawing data for indicating drawing of an area in the drawing area of said component except for its drawing area overlapped with the other component if the drawing order of said component is earlier than the drawing order of the other component, or drawing data for indicating drawing of all drawing area of said component if the drawing order of said component is later than the drawing order of the other component. Thus, there is produced such an effect that it is possible to generate drawing data by which wasteful drawing processing is eliminated so that the processing load in drawing processing becomes smaller.

Namely, there is produced such an effect that it is possible to generate drawing data that is without the need of performing wasteful drawing processing in an overlapped area between plural components.

Further, according to Embodiment 1, it is configured so that the graphics accelerator 3c of the display device 3 recognizes the drawing orders of the respective components with reference to the information indicative of the drawing orders of the respective components included in the real device data generated by the drawing-data generation unit 14, to thereby draw on the display 3d in precedence order of the component in the drawing orders according to the drawing data of said component. This results in no need of performing wasteful drawing processing in an overlapped area between plural components (the processing load in drawing processing becomes smaller), and as a result, there is produced such an effect that an enhanced drawing performance can be achieved.

### Embodiment 2

In above Embodiment 1, such a device is shown in which, when the presence of another component having an overlap in drawing area with the component is confirmed, the drawing-data generation unit 14 compares the drawing order of said component with the drawing order of the other component having the overlap in drawing area, to thereby generate drawing data for indicating drawing of an area in the drawing area of said component except for its drawing area overlapped with the other component if the drawing order of said component is earlier than the drawing order of the other component; however, in the case where the component drawing processing in the graphics accelerator 3c of the display device 3 is to be performed in a direction along a scan line (drawing of each pixel is performed while being shifted sequentially from the left end of the screen toward the right side of the screen), it is allowed that the drawing-data generation unit 14 determines an overlapped section and a non-overlapped section on the scan line between the drawing area of said component and the drawing area of the other component according to a predetermined filling rule for a closed area (for example, an EVEN/ODD rule), to thereby generate drawing data for indicating drawing of the non-overlapped section without drawing of the overlapped section.

This will be specifically described below.

Here, description will be made about a case where an EVEN/ODD rule in vector graphics drawing is used as the filling rule for a closed area; however, the filling rule for a closed area is not limited to the EVEN/ODD rule, and another rule may be used.

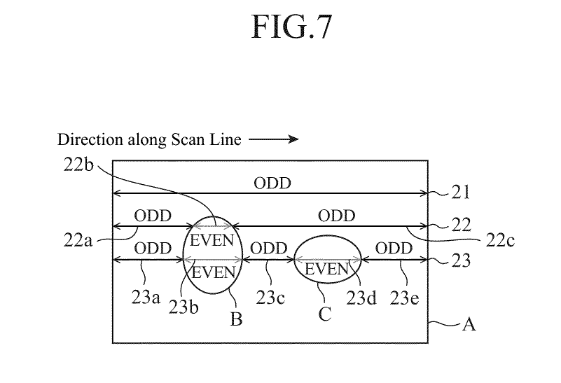

FIG. 7 is an illustration diagram showing the EVEN/ODD rule in vector graphics drawing.

In FIG. 7, there is shown an example in which Component A provided as a background and Components B and C placed in the drawing area of Component A are present.

The EVEN/ODD rule is a rule of dividing into drawing sections bordered by the positions of boundaries in drawing area of a plurality of components, in which the drawing section is determined to be an ODD section to be filled (non-overlapped section) if it is a section appearing in the order of odd number counted from the left end of the screen, or to be an EVEN section not to be filled (overlapped section) if it is a section appearing in the order of even number.

In FIG. 7, since Components B and C are not placed in the drawing area of Component A in a spline 21, this section is all given as a section appearing in the order of ODD number (the first appearing section). Thus, the section of the spline 21 is all given as an ODD section.

Accordingly, with respect to the drawing processing of the spline 21, the drawing-data generation unit 14 refers to the design data to thereby generate drawing data by which all pixels on the spline 21 are each drawn in a specified color.

Next, in a spline 22, since Component B is placed in the drawing area of Component A, there are two boundary points between Component A and Component B.

In the spline 22, since a section 22a from the left end of the screen until the left-side boundary point is provided as a section appearing in the order of odd number (the first appearing section), the section 22a is provided as an ODD section.

Further, since a section 22b from the left-side boundary point until the right-side boundary point is provided as a section appearing in the order of even number (the second appearing section), the section 22b is provided as an EVEN section.

Furthermore, in the spline 22, since a section 22c from the right-side boundary point until the right end of the screen is provided as a section appearing in the order of odd number (the third appearing section), the section 22c is provided as an ODD section.

Accordingly, with respect to the drawing processing of the spline 22, the drawing-data generation unit 14 generates drawing data by which all pixels on the sections 22a, 22c that are ODD sections are each drawn in a specified color, but all pixels on the section 22b that is an EVEN section are not drawn.

Next, in a spline 23, since Component B and C are placed in the drawing area of Component A, there are four boundary points between Component A and Components B, C.

In the spline 23, since a section 23a from the left end of the screen until the leftmost-side boundary point is provided as a section appearing in the order of odd number (the first appearing section), the section 23a is provided as an ODD section.

Further, since a section 23b from the leftmost-side boundary point until the second boundary point is provided as a section appearing in the order of even number (the second appearing section), the section 23b is provided as an EVEN section.

Since a section 23c from the second boundary point until the third boundary point in the order from the left side, is provided as a section appearing in the order of odd number (the third appearing section), the section 23c is provided as an ODD section.

Furthermore, a section 23d from the third boundary point until the fourth boundary point in the order from the left side, is provided as a section appearing in the order of even number (the fourth appearing section), the section 23d is provided as an EVEN section.

Since a section 23e from the fourth boundary point until the fifth boundary point, in the order from the left side, is provided as a section appearing in the order of odd number (the fifth appearing section), the section 23e is provided as an ODD section.

Accordingly, with respect to the drawing processing of the spline 23, the drawing-data generation unit 14 generates drawing data by which all pixels on the sections 23a, 23c, 23c that are ODD sections are each drawn in a specified color, but all pixels on the sections 23b, 23d that are EVEN sections are not drawn.

Here, description has been made about a case of drawing the screen in FIG. 7 by the EVEN/ODD rule; however, the EVEN/ODD rule may also be used for drawing the screen in FIG. 6 having been used in the description of Embodiment 1.

For example, at the time of drawing Component A, sections in the drawing area of Component A overlapped with Component B, Component D and Component E are provided as EVEN sections as shown at FIG. 6(a), so that there is generated drawing data by which drawing of pixels in these sections are not performed.

Meanwhile, a section in the drawing area of Component A not overlapped with Component B, Component D and Component E is provided as an ODD section, so that there is generated the drawing data by which pixels in that section are each drawn in a specified color.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

The drawing data generation device according to the invention is provided with the drawing-order determination processor, the overlapped-component search processor and the drawing-data generation processor, and can eliminate wasteful drawing processing to thereby reduce the processing load in drawing processing, and thus, it is well-suited to generation of the drawing data of the screen formed of a plurality of components.

### DESCRIPTION OF REFERENCE NUMERALS AND SIGNS

1: design tool, 2: drawing data generation device, 3: display device, 3a: CPU, 3b: memory, 3c: graphics accelerator (component drawing processor), 3d: display, 11: design-data input unit, 12: drawing-order determination unit (drawing-order determination processor), 13: overlapped-component search unit (overlapped-component search processor), 14: drawing-data generation unit (drawing-data generation processor), 15: real-device data output unit, 21, 22, 23: splines, 22a, 22c, 23a, 23c, 23e: ODD sections, 22b, 23b, 23d: EVEN sections.

1: A drawing data generation device, comprising:
a drawing-order determination processor that determines drawing orders of a plurality of components for forming a screen, according to a drawing rule in which, among the plurality of components, the component used for a background is firstly drawn followed by drawing so that the more the component is to be placed toward a front side of the screen, the later the component is drawn;
an overlapped-component search processor that compares drawing areas of the plurality of components for forming the screen to each other, to thereby search a component having an overlap in drawing area with another component; and
a drawing-data generation processor that, with respect to the components to be drawn, generates as drawing data of said component drawing data for indicating drawing of all drawing area of the component when another component having an overlap in drawing area with said component has not been searched by the overlapped-component search processor, while generating as the drawing data of said component, when another component having an overlap in drawing area with said component has been searched by the overlapped-component search processor, drawing data for indicating drawing of an area in the drawing area of said component except for its drawing area overlapped with the other component if the drawing order of said component is earlier than the drawing order of the other component, or generating as the drawing data of said component drawing data for indicating drawing of all drawing area of said component if the drawing order of said component is later than the drawing order of the other component, to generate the drawing data in a unit of said component.

2: The drawing data generation device of claim 1, wherein, when component drawing processing in a display device is to be performed in a direction along a scan line, the drawing-data generation processor determines an overlapped section and a non-overlapped section on the scan line between the drawing area of said component and the drawing area of the other component, according to a predetermined filling rule for a closed area, to thereby generate drawing data for indicating drawing of the non-overlapped section without drawing of the overlapped section.

3: The drawing data generation device of claim 2, wherein the drawing-data generation processor uses an EVEN/ODD rule in vector graphics drawing, as the predetermined filling rule for a closed area.

4: A drawing data generation method, comprising:
a drawing-order determination processing step in which a drawing-order determination processor determines drawing orders of a plurality of components for forming a screen, according to a drawing rule in which, among the plurality of components, the component used for a background is firstly drawn followed by drawing so that the more the component is to be placed toward a front side of the screen, the later the component is drawn;
an overlapped-component search processing step in which an overlapped-component search processor compares drawing areas of the plurality of components for forming the screen to each other, to thereby search a component having an overlap in drawing area with another component; and
a drawing-data generation processing step in which, with respect to the components to be drawn, a drawing-data generating processor generates as drawing data of said component drawing data for indicating drawing of all drawing area of the component when another component having an overlap in drawing area with said component has not been searched in the overlapped-component search processing step, while generating as the drawing data of said component, when another component having an overlap in drawing area with said component has been searched in the overlapped-component search processing step, drawing data for indicating drawing of an area in the drawing area of said component except for its drawing area overlapped with the other component if the drawing order of said component is earlier than the drawing order of the other component, or generating as the drawing data of said component drawing data for indicating drawing of all drawing area of said component if the drawing order of said component is later than the drawing order of the other component, to generate the drawing data in a unit of said component.

5: A display device which comprises a component drawing processor that makes reference to drawing data of the respective components generated by the drawing data generation device of claim 1 and information indicative of the drawing orders of the respective components determined by the drawing data generation device, to thereby perform drawing in precedence order of the component in the drawing orders, according to the drawing data of said component.
